(19) United States
(12) Patent Application Publication
(10) Pub. No.: US 2024/0067039 A1
(43) Pub. Date: Feb. 29, 2024

(54) SERVER AND VEHICLE MANAGEMENT METHOD

(71) Applicant: TOYOTA JIDOSHA KABUSHIKI KAISHA, Toyota-shi (JP)

(72) Inventors: Osamu YUMITA, Seto-shi (JP); Yoichi ONISHI, Okazaki-shi (JP); Toru ANDO, Obu-shi (JP); Ikuma SUZUKI, Okazaki-shi (JP); Yu NAGATA, Chofu-shi (JP)

(73) Assignee: TOYOTA JIDOSHA KABUSHIKI KAISHA, Toyota-shi (JP)

(21) Appl. No.: 18/332,297

(22) Filed: Jun. 9, 2023

(30) Foreign Application Priority Data
Aug. 26, 2022 (JP) 2022-135021

(51) Int. Cl. B60L 55/00; B60L 53/66; B60L 53/68; G01C 21/34

(52) U.S. Cl. CPC B60L 55/00; B60L 53/66; B60L 53/68; G01C 21/3484; H02J 3/322

(57) ABSTRACT

An operation management server manages a vehicle equipped with a battery able to store regenerated electric power. The operation management server includes: a processor that generates a message to be transmitted to the vehicle; and a storage that stores traveling histories of a plurality of vehicles. The processor estimates a transition in a power storage amount of the battery on a planned travel route of the vehicle based on a travel plan of the vehicle and the travel histories of the vehicles. The processor generates the message for proposing execution of external power supply from the battery to an outside of the vehicle before the power storage amount reaches a predetermined amount, when an estimation is made that the power storage amount will exceed the predetermined amount on the planned travel route.

### CROSS-REFERENCE TO RELATED APPLICATION

This application claims priority to Japanese Patent Application No. 2022-135021 filed on Aug. 26, 2022, incorporated herein by reference in its entirety.

### BACKGROUND

### 1. Technical Field

The present disclosure relates to a server and a vehicle management method, and more particularly to management technology for a vehicle equipped with a battery capable of storing regenerated electric power.

### 2. Description of Related Art

A power sale information notification device disclosed in Japanese Unexamined Patent Application Publication No. 2018-170823 (JP 2018-170823 A) includes a power sale information acquisition unit, a notification output unit, and a vehicle-side control unit. The power sale information acquisition unit acquires power sale information requesting power sale from a charging system located around a travel route from the current location to the destination of the vehicle. The notification output unit outputs a notification related to the power sale information to a display medium. When determining that the power can be sold to the charging system, the vehicle-side control unit controls the notification output unit so that the notification output unit outputs to the display medium a notification related to the power sale information in the charging system.

### SUMMARY

Demands for effective use of electric power stored in batteries mounted on vehicles are increasing in line with the recent increase in environmental awareness and the tightening of electric power supply and demand. In particular, the inventors of the present disclosure focused on a situation (described later) in which electric power may be wasted in a vehicle equipped with a battery capable of storing regenerated electric power.

The present disclosure has been made to solve the above issue, and one of the purposes of the present disclosure is to effectively utilize electric power in a vehicle equipped with a battery capable of storing regenerated electric power.

(1) A server according to an aspect of the present disclosure manages a vehicle equipped with a battery able to store regenerated electric power. The server includes: a processor that generates a message to be transmitted to the vehicle; and a storage that stores traveling histories of a plurality of vehicles. The processor estimates a transition in a power storage amount of the battery on a planned travel route of the vehicle based on a travel plan of the vehicle and the travel histories of the vehicles. The processor generates the message for proposing execution of external power supply from the battery to an outside of the vehicle before the power storage amount reaches a predetermined amount, when an estimation is made that the power storage amount will exceed the predetermined amount on the planned travel route.

In configuration (1) above, when the power storage amount of the battery of the vehicle is expected to exceed a predetermined amount, the server generates a message proposing external power supply in advance and transmits the message to the vehicle. When the user of the vehicle accepts the proposal, the power storage amount of the battery will decrease, creating a margin for storing the regenerated electric power. Therefore, according to the configuration (1) above, it is possible to prevent the power storage amount of the battery from exceeding a predetermined amount, and to effectively utilize the regenerated electric power.

(2) The processor generates the message to include one or more power supply facilities for which a delay in arrival time of the vehicle at the destination location when the external power supply is executed is within a predetermined time compared to when the external power supply is not executed.

According to the configuration (2) above, the detour accompanying the external power supply does not become an excessive detour, so the travel plan (user's schedule) of the vehicle is not greatly disturbed. Therefore, the regenerated electric power can be utilized effectively without impairing user's convenience.

(3) The processor generates the message such that a route from a current location of the vehicle to the one or more power supply facilities is displayed on a map.

According to the configuration (3) above, the user can easily reach the one or more power supply facilities.

(4) The processor estimates the transition in the power storage amount on the planned travel route based on a travel plan related to downhill travel of the vehicle and travel histories related to downhill travels of the vehicles.

According to the configuration (4) above, it is possible to estimate transitions in the state of charge (SOC).

(5) The one or more power supply facilities includes a specific power supply facility configured to supply electric power supplied from the vehicle to a vehicle managed by a pre-registered business operator. The processor generates the message so as to preferentially propose the specific power supply facility over a power supply facility other than the specific power supply facility.

According to the above configuration (5), pre-registered business operators (transportation business operators, delivery business operators, etc.) are preferentially supplied with electric power, and electric power for vehicle travel can be secured more reliably.

(6) The one or more power supply facilities include a first power supply facility that requires conversion of direct current power from the battery to alternating current power, and a second power supply facility that allows direct supply of direct current power from the battery. The processor generates the message so as to preferentially propose the second power supply facility over the first power supply facility.

According to the configuration (6) above, since DC-AC conversion is not required, power loss due to the external power supply can be reduced.

(7) A vehicle management method according to another aspect of the present disclosure manages, by a computer, a vehicle equipped with a battery able to store regenerated electric power. The vehicle management method includes first and second steps. The first step is a step of estimating a transition in a power storage amount of the battery on a planned travel route of the vehicle based on a travel plan of the vehicle and travel histories of a plurality of vehicles. The second step is a step of proposing, to the vehicle, execution of external power supply from the battery to an outside of the vehicle before the power storage amount reaches a predetermined amount, when an estimation is made that the power storage amount will exceed the predetermined amount on the planned travel route.

According to the method (7) above, electric power can be utilized effectively, as in the configuration (1) above.

According to the present disclosure, electric power can be effectively utilized in a vehicle equipped with a battery capable of storing regenerated electric power.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of an overall configuration of a power management system according to an embodiment of the present disclosure;

FIG. 2 is a diagram showing an example of a configuration of an operation management system of a vehicle;

FIG. 3 is a diagram showing an example of a travel route of the vehicle;

FIG. 4 is a diagram showing an example of a travel plan of a vehicle in a comparative example;

FIG. 5 is a diagram illustrating an example of a travel plan of the vehicle according to the present embodiment; and

FIG. 6 is a flowchart showing a processing procedure executed by an operation management server and the vehicle.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### Embodiment

Overall Configuration of Power Management System

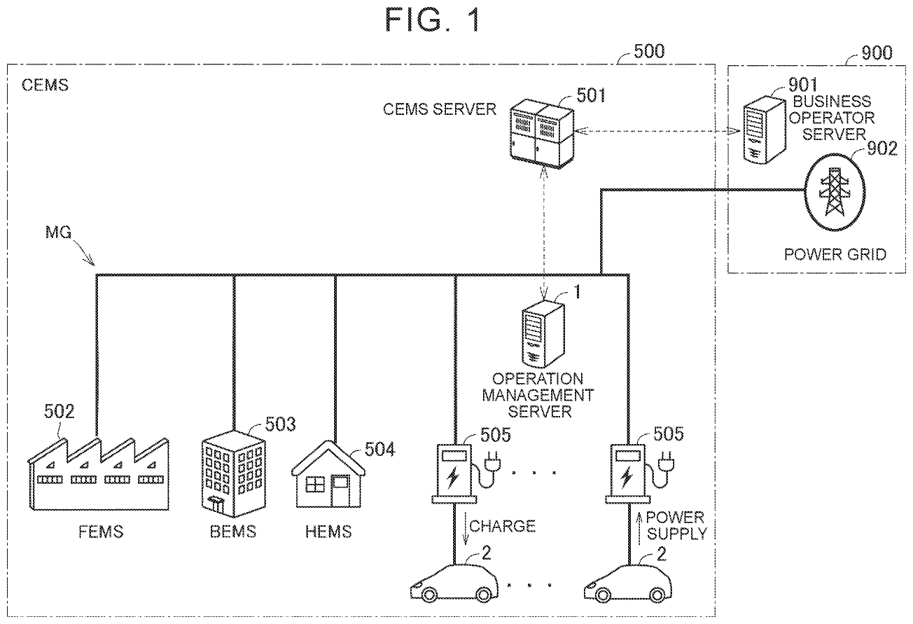

FIG. 1 is a diagram illustrating an example of an overall configuration of a power management system according to an embodiment of the present disclosure. The power management system includes a CEMS 500 and a power system 900 operated by a power company (general electric power company, specified-scale power company, etc.). The CEMS means a community energy management system or a city energy management system.

The CEMS 500 includes a CEMS server 501. The CEMS server 501 is a computer that manages power adjustment resources within the CEMS 500. The CEMS 500 includes, as power adjustment resources, a factory energy management system (FEMS) 502, a building energy management system (BEMS) 503, a home energy management system (HEMS) 504, and electric vehicle supply equipment (EVSE) 505. Although not shown, the CEMS 500 may also include other power adjustment resources such as generators, variable renewable power sources, power storage systems, and the like. In the CEMS 500, a microgrid MG is built with these various power adjustment resources.

The FEMS 502 is a system that manages the supply and demand of electric power used in factories, and includes factory buildings (lighting fixtures, air conditioning equipment, etc.) and industrial equipment (production lines, etc.) that operate with electric power supplied from the microgrid MG. The BEMS 503 is a system that manages the supply and demand of electric power used in buildings such as offices and commercial facilities, and includes lighting fixtures, air conditioning equipment, and the like installed in the building. The HEMS 504 is a system that manages the supply and demand of electric power used at home, and includes home appliances (lighting equipment, air conditioners, other electric appliances, etc.) that operate with electric power supplied from the microgrid MG.

The EVSE 505 is typically a commercial or public charging station. The EVSE 505 may be a home-installed charger. The EVSE 505 is electrically connected to the microgrid MG and configured to be chargeable and dischargeable with the microgrid MG.

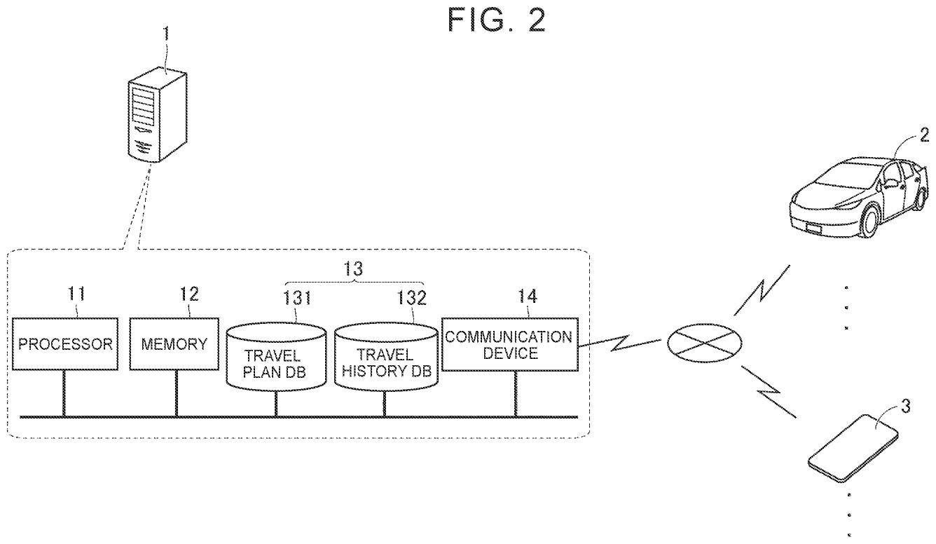

The CEMS 500 further includes an operation management server 1 and multiple vehicles 2. The operation management server 1 manages traveling (operation) of the vehicles 2. The operation management server 1 is configured to be able to bi-directionally communicate with the CEMS server 501. The operation management server 1 corresponds to the “server” according to the present disclosure. The configuration of the operation management system for the vehicles 2 using the operation management server 1 will be described in detail with reference to FIG. 2.

Each of the vehicles 2 is a vehicle equipped with a battery capable of storing regenerated electric power, and is specifically a plug-in hybrid electric vehicle (PHEV), a battery electric vehicle (BEV), a fuel cell electric vehicle (FCEV), or the like. The vehicle 2 is configured to be able to supply electric power from the microgrid MG to the vehicle 2 (external charging). Furthermore, the vehicle 2 is configured to be able to supply electric power from the vehicle 2 to the microgrid MG (external power supply). That is, the vehicle 2 is configured to be capable of both external charging and external power supply.

Although not shown, the vehicle 2 is equipped with a navigation device including a global positioning system (GPS) receiver capable of specifying the current location of the vehicle 2. The vehicle 2 is also equipped with a data communication module (DCM) capable of transmitting various data/information of the vehicle 2 to the outside. Note that the travel route of the vehicle 2 may be set by a user terminal 3 (see FIG. 2).

The power system 900 includes a business operator server 901 and a power grid 902. The business operator server 901 is a computer that belongs to a power transmission and distribution business operator (typically an electric power company) and manages power supply and demand of the power grid 902. The business operator server 901 is also configured to be able to communicate bi-directionally with the CEMS server 501. The power grid 902 is a power network built with power plants and power transmission and distribution facilities.

Configuration of Operation Management System

FIG. 2 is a diagram showing an example of the configuration of the operation management system of the vehicles 2. The operation management server 1 includes a processor 11, a memory 12, a storage 13, and a communication device 14. Components of the operation management server 1 are connected to each other by a bus (data line).

The processor 11 is, for example, a central processing unit (CPU) or a micro processing unit (MPU), and is configured to execute predetermined arithmetic processes described in a program. However, in the present specification, the “processor” is not limited to a narrowly defined processor that executes processes in a stored program method, and may include hardwired circuits such as application specific integrated circuit (ASIC) and field-programmable gate array (FPGA). As such, the term “processor” may be used interchangeably with processing circuitry whose processes are pre-defined by computer readable codes and/or hardwired circuitry.

The memory 12 includes a random access memory (RAM) and a read-only memory (ROM). The ROM stores programs executed by the processor 11 and various information (maps, relational expressions, parameters, etc.) used in the programs. The RAM temporarily stores data generated by execution of programs in the processor 11 and data input via the communication device 14. The RAM also functions as temporary data memory that is used as a working area.

The storage 13 is a rewritable non-volatile memory such as a hard disk drive (HDD), a solid state drive (SSD), or the like. The storage 13 includes a travel plan database 131 and a travel history database 132.

The travel plan database 131 stores data on travel plans (operation plans) of each of the vehicles 2. More specifically, the travel plan database 131 stores the current state of charge of the battery of each vehicle 2 (indicated by SOC in this example). Also, the travel plan database 131 stores the planned travel route from the current location to the destination location of each vehicle 2.

The travel history database 132 stores data related to travel histories (operation results) of each of the vehicles 2. More specifically, the travel history database 132 stores data on power consumption and regenerated electric power measured while each vehicle 2 is traveling, for each vehicle type (type/model) and for each of various travel conditions (travel route, vehicle speed, date, day of the week, weather, temperature, etc.). The travel history database 132 may further include other travel conditions that may affect power consumption and regenerated electric power, such as indexes indicating the driver's driving tendency (frequency of sudden acceleration/deceleration, etc.), air conditioning system on/off, tire pressure, traffic congestion, etc.

The communication device 14 includes a communication interface with a network such as the Internet. The communication device 14 is configured to be able to communicate bi-directionally with an external device of the operation management server 1, specifically the CEMS server 501 (see FIG. 1), a plurality of vehicles 2, a plurality of user terminals 3, and a plurality of EVSEs 505 (see FIG. 1). The user terminal 3 is a terminal that can be operated by the user of the vehicle 2, such as a smart phone, a tablet, or a personal computer (PC).

The operation management server 1 is configured to execute the following processes via the communication device 14. The operation management server 1 receives a power supply and demand adjustment request from the CEMS server 501. The operation management server 1 collects position information based on the GPS receiver (not shown) from each vehicle 2 and collects the SOC of the battery. Further, the operation management server 1 collects the travel conditions described above. The operation management server 1 also transmits various messages to the vehicle 2 to be displayed on the multi-information display (MID) (not shown) of the vehicle 2. The operation management server 1 may transmit a message to the user terminal 3. The operation management server 1 can also acquire the availability of the EVSE 505 and reserve the EVSE 505.

Travel Plan and Travel History

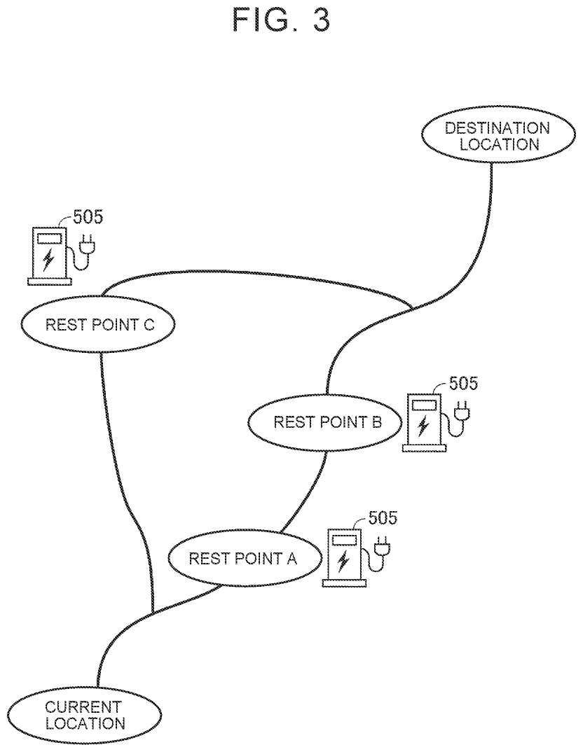

FIG. 3 is a diagram showing an example of a travel route of the vehicle 2. In this example, it is assumed that the vehicle 2 travels from the current location to the destination location. Rest points A and B exist on a travel route R1 of the vehicle 2 between the current location and the destination location. A rest point C exists on another travel route R2 between the current location and the destination location. The rest points A to C are, for example, service areas or roadside stations, but may also be commercial facilities (shopping malls, restaurants, etc.). The EVSE 505 is installed at each rest point A to C. Here, in order to facilitate understanding of the characteristics of the operation management server 1 according to the present embodiment, first, a travel plan for a vehicle 2 (a specific vehicle) in a comparative example will be described.

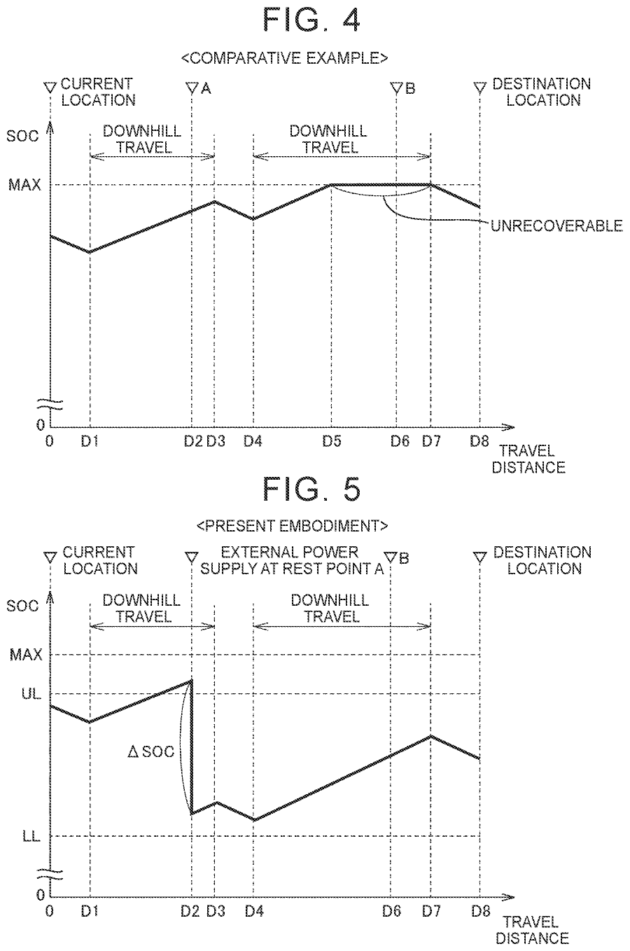

FIG. 4 is a diagram showing an example of a travel plan of the vehicle 2 in a comparative example. In FIGS. 4 and 5, the horizontal axis represents the distance along the travel route (R1 in this example) from the current location of the vehicle 2 to the destination location. The vertical axis represents the SOC of the battery mounted on the vehicle 2.

In this example, it is assumed that the SOC of the battery is already high at the current location of the vehicle 2. The vehicle 2 travels downhill on the route from D1 to D3. This increases the SOC of the battery. On the route from D4 to D8, the vehicle 2 further travels downhill. As a result, the SOC of the battery further increases and reaches the maximum value MAX (typically MAX=100%). In this case, in the section from D5 to D7 where the SOC of the battery reaches MAX, the regenerated electric power that can be originally recovered if the SOC of the battery is low cannot be recovered. Therefore, the power consumption and/or fuel consumption of the vehicle 2 is reduced, and electric power is wasted in the microgrid MG of the CEMS 500 as well.

Therefore, in the present embodiment, a configuration is adopted in which, when the SOC of the battery is expected to exceed the upper limit value UL of the appropriate range, execution of external power supply from the battery to the microgrid MG of the CEMS 500 via the EVSE 505 is proposed.

FIG. 5 is a diagram illustrating an example of a travel plan of the vehicle 2 according to the present embodiment. In the present embodiment, external power supply of the vehicle 2 is executed at D2 (rest point A in this example) located partway through the downhill travel from D1 to D3. The operation management server 1 determines based on the travel histories of the vehicles 2 whether the SOC of the battery will exceed the upper limit value UL when the target vehicle 2 travels from the current location to the destination location along the planned travel route. The upper limit value UL (corresponding to the “predetermined amount” according to the present disclosure) is a value lower than the maximum value MAX, and, for example, UL=90%. When the SOC of the battery is expected to exceed the upper limit value UL, the operation management server 1 generates a message proposing external power supply and transmits the message to the vehicle 2 and/or the user terminal 3. This message is transmitted before the SOC of the battery exceeds the upper limit value UL.

When the user of the vehicle 2 executes the external power supply in accordance with the proposal from the operation management server 1, the SOC of the battery drops significantly (the amount of drop is indicated by ASOC). Therefore, it is possible to prevent the SOC of the battery from reaching the maximum value MAX in the subsequent route from D4 to D7. As a result, it is possible to suppress a decrease in the power consumption and/or fuel consumption of the vehicle 2 and to suppress wasteful power generation in the CEMS 500.

Note that, in general, a battery in a high SOC state is likely to deteriorate. Therefore, when the SOC of the battery is maintained at the maximum value MAX, the deterioration of the battery may progress. By setting the upper limit value UL and suppressing the SOC from reaching the maximum value MAX, deterioration of the battery can be suppressed.

It is desirable that the amount of electric power to be externally supplied, that is, the SOC decrease amount ASOC, is set so that the SOC does not reach the lower limit value LL (for example, LL=20%) of the proper range while the vehicle 2 is traveling on the planned travel route.

Processing Flow

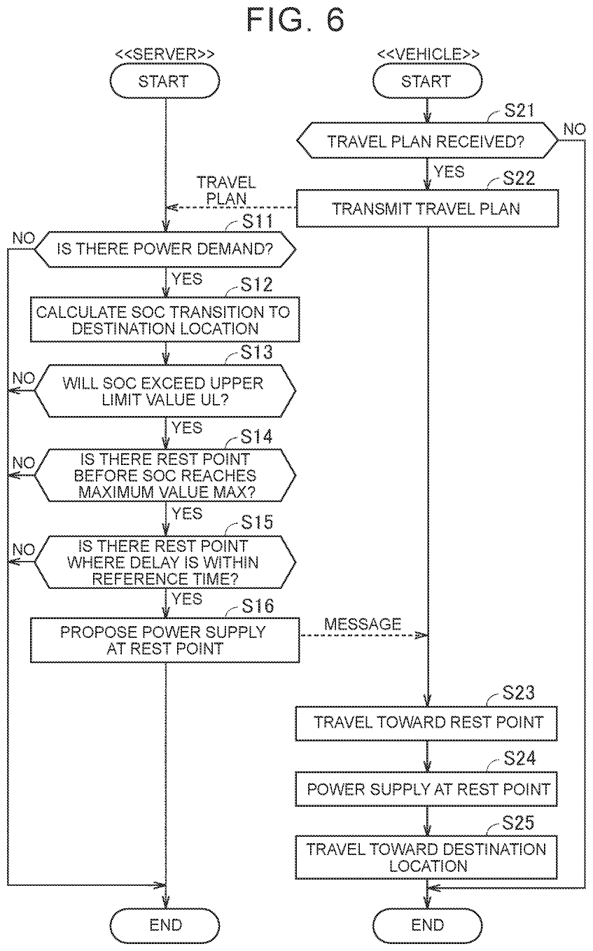

FIG. 6 is a flowchart showing a processing procedure executed by the operation management server 1 and the vehicle 2. The processes shown in this flowchart are executed when a predetermined condition is satisfied (for example, at predetermined intervals). In the figure, a series of processes executed by the operation management server 1 is shown on the left side, and a series of processes executed by the vehicle 2 is shown on the right side. Each process executed by the operation management server 1 is realized by software processing by the processor 11, but may be realized by hardware (electric circuit) disposed in the operation management server 1. The same applies to the vehicle 2 as well. Hereinafter, the step is abbreviated as S.

The operation management server 1 periodically collects position information and SOC information of each vehicle 2. Also, as described above, the operation management server 1 constantly collects travel histories of a large number of vehicles 2 including the target vehicle 2.

In S21, the vehicle 2 determines whether the travel plan for the vehicle 2 has been received. For example, the user inputs the destination location of the vehicle 2 by operating a navigation device using the MID (neither of which is shown) of the vehicle 2. Then, based on road congestion information and the like, a travel plan is generated that includes the planned travel route from the current location of the vehicle 2 to the destination location and the estimated passage times at each point on the route. When the travel plan for the vehicle 2 is received (YES in S21), the vehicle 2 transmits the generated travel plan to the operation management server 1 (S22).

In S11, the operation management server 1 acquires from the CEMS server 501 information regarding whether there is a high power demand at present or in the near future, such as information that a shortage of demand is expected within the CEMS 500 (microgrid MG). When the power supply is excessive with respect to the power demand (NO in S11), subsequent processes may be skipped.

When the power demand is high (YES in S11), the operation management server 1 stores in the travel plan database 131 the travel plan received from the vehicle 2. Further, the operation management server 1 calculates the transition of the SOC (see FIG. 4) on the planned travel route of the vehicle 2 based on the received travel plan and the travel history stored in the travel history database 132 (S12). More specifically, the operation management server 1 can estimate the SOC change in the vehicle 2 on the planned travel route of the vehicle 2, based on the travel histories collected under similar travel conditions from many vehicles of the same vehicle type (type/model) as the vehicle 2. Then, the operation management server 1 can calculate the transition of the SOC on the planned travel route of the vehicle 2 based on the current SOC of the vehicle 2 and the estimated SOC change.

In S13, the operation management server 1 determines whether the SOC transition calculated in S12 will exceed the upper limit value UL (see FIG. 5). When the SOC is expected to exceed the upper limit value UL (YES in S13), the operation management server 1 advances the process to S14 to extract candidates for points where external power supply is possible. The points where external power supply is possible are desirably rest points such as service areas, roadside stations, and commercial facilities as described with reference to FIG. 3. This is because the waiting time for the external power supply can be used for eating, shopping, leisure, and the like.

In S14, the operation management server 1 determines whether there is a rest point that can be reached before the SOC of the battery of the vehicle 2 reaches the maximum value MAX on or near the planned travel route of the vehicle 2. In the example described with reference to FIG. 3, there are rest points A to C. However, as shown in FIG. 4, at rest point B, the SOC of the battery of vehicle 2 reaches the maximum value MAX. Therefore, the rest point B is excluded from the candidate points where external power supply is possible. When there is a rest point that can be reached before the SOC of the battery reaches the maximum value MAX (YES in S14), the operation management server 1 advances the process to S15.

In S15, the operation management server 1 determines whether there is a rest point where the delay due to external power supply is within the reference time on or near the planned travel route of the vehicle 2. In other words, the operation management server 1 determines whether the detour associated with external power supply will result in an excessive detour. When the rest point C is selected in the example described with reference to FIG. 3, the vehicle 2 has to make a large detour from the planned travel route, and the associated delay (time delay associated with external power supply) is longer than the reference time. The reference time is, for example, 15 minutes, but can be set to any time such as 30 minutes or 1 hour. If the arrival at the destination location is significantly delayed due to the external power supply, the impact on the user's schedule is large, which is inconvenient for the user. Therefore, the rest point C is excluded from the candidate points where external power supply is possible. As a result, in this example, the rest point A is extracted where the SOC does not reach the maximum value MAX and the delay is within the reference time.

When there is a rest point where the delay is within the reference time (YES in S15), the operation management server 1 advances the process to S16 and generates a message proposing a rest point where external power supply is possible. The operation management server 1 then transmits the generated message to the vehicle 2.

Here, it is desirable that the operation management server 1 generates a message so that a route from the current location of the vehicle 2 to the rest point where external power supply is possible is displayed on the map. This allows the user to easily reach the rest point.

The EVSE 505 includes a facility (first power supply facility) that requires conversion of direct current (DC) power from the in-vehicle battery into alternating current (AC) power, and a facility (second power supply facility) in which DC power can be directly supplied from the in-vehicle battery. It is desirable that the operation management server 1 preferentially proposes the second power supply facility over the first power supply facility. As a result, power loss due to power conversion can be reduced.

It is desirable that the operation management server 1 preferentially proposes an EVSE 505 that is not in use or reserved over an EVSE 505 that is in use or reserved. As a result, the waiting time for external power supply can be shortened.

The operation management server 1 may preferentially propose an EVSE 505 connected to the electric power facility (such as an electric power storage system) so that the power externally supplied from the vehicle 2 is transmitted to the electric power facility (power storage system, etc.) managed by a specific business operator. As a specific example, transportation companies, home delivery companies, and the like require a large amount of electric power (power amount) for vehicle travel. These business operators are registered in advance by, for example, concluding a contract with the administrator of the operation management server 1. As a result, the business operator can preferentially receive power supply and more reliably secure power for vehicle travel.

When the SOC is not expected to exceed the upper limit value UL (NO in S13), when there is no rest point that can be reached before the SOC reaches the maximum value MAX (NO in S14), or when there is no rest point where the delay is within the reference time (NO in S15), the process of S16 is skipped. Note that the processes of S14 and S15 are not essential.

The vehicle 2 travels to the rest point in accordance with the message received from the operation management server 1 (S23). When multiple rest points are proposed, the user of the vehicle 2 can appropriately select the rest point according to his/her desire. When the vehicle 2 arrives at the rest point, external power is supplied from the vehicle 2 to the microgrid of the CEMS 500 via the EVSE 505 (S24). After that, the vehicle 2 travels from the rest point toward the destination location (S25).

As described above, in the present embodiment, when the SOC of the battery of the vehicle 2 is expected to exceed the upper limit value UL, the operation management server 1 generates a message proposing external power supply in advance, and transmits the message to vehicle 2. When the user of the vehicle 2 accepts the proposal, the SOC of the battery will drop, creating a margin for storing the regenerated electric power. Therefore, according to the present embodiment, the SOC of the battery can be prevented from exceeding the upper limit value UL, and the regenerated electric power can be used effectively.

In addition, the operation management server 1 proposes a rest point where the delay due to external power supply is within the reference time, and excludes a rest point where the delay exceeds the reference time from the proposal. As a result, the detour accompanying the external power supply does not become an excessive detour, so the travel plan (user's schedule) of the vehicle 2 is not greatly disturbed. This is because the present embodiment is based on the idea that the user's convenience is emphasized rather than power waste control.

The embodiment disclosed herein should be considered to be exemplary and not restrictive in all respects. The scope of the present disclosure is shown by the scope of claims rather than the description of the above embodiments, and is intended to include all modifications within the meaning and the scope equivalent to the scope of claims.

What is claimed is:

1. A server that manages a vehicle equipped with a battery able to store regenerated electric power, the server comprising:
a processor that generates a message to be transmitted to the vehicle; and
a storage that stores traveling histories of a plurality of vehicles, wherein the processor
estimates a transition in a power storage amount of the battery on a planned travel route of the vehicle based on a travel plan of the vehicle and the travel histories of the vehicles, and
generates the message for proposing execution of external power supply from the battery to an outside of the vehicle before the power storage amount reaches a predetermined amount, when an estimation is made that the power storage amount will exceed the predetermined amount on the planned travel route.

2. The server according to claim 1, wherein the processor generates the message to include one or more power supply facilities for which a delay associated with the external power supply is within a reference time compared to when the external power supply is not executed.

3. The server according to claim 2, wherein the processor generates the message such that a route from a current location of the vehicle to the one or more power supply facilities is displayed on a map.

4. The server according to claim 3, wherein the processor estimates the transition in the power storage amount on the planned travel route based on a travel plan related to downhill travel of the vehicle and travel histories related to downhill travels of the vehicles.

5. The server according to claim 2, wherein
the one or more power supply facilities includes a specific power supply facility configured to supply electric power supplied from the vehicle to a vehicle managed by a pre-registered business operator, and
the processor generates the message so as to preferentially propose the specific power supply facility over a power supply facility other than the specific power supply facility.

6. The server according to claim 2, wherein
the one or more power supply facilities include a first power supply facility that requires conversion of direct current power from the battery to alternating current power, and a second power supply facility that allows direct supply of direct current power from the battery, and
the processor generates the message so as to preferentially propose the second power supply facility over the first power supply facility.

7. A vehicle management method for managing, by a computer, a vehicle equipped with a battery able to store regenerated electric power, the vehicle management method comprising:
estimating a transition in a power storage amount of the battery on a planned travel route of the vehicle based on a travel plan of the vehicle and travel histories of a plurality of vehicles; and
proposing, to the vehicle, execution of external power supply from the battery to an outside of the vehicle before the power storage amount reaches a predetermined amount, when an estimation is made that the power storage amount will exceed the predetermined amount on the planned travel route.
